(19) United States
(12) Patent Application Publication
(10) Pub. No.: US 2009/0168624 A1
(43) Pub. Date: Jul. 2, 2009

(54) APPARATUS AND METHOD FOR RECORDING A CUSTOM COMPACT DISC AT A RETAIL PREMISES

(76) Inventor: Marco Scibora, St. Paul, MN (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 12/399,005

(22) Filed: Mar. 5, 2009

Related U.S. Application Data
(63) Continuation-in-part of application No. 09/266,183, filed on Mar. 10, 1999, now abandoned.
Application No. 09/266,183 is a continuation-in-part of application No. 09/007,530, filed on Jan. 15, 1998, now Pat. No. 6,195,436.
Application No. 09/007,530 is a continuation of application No. 08/760,640, filed on Dec. 4, 1996, now abandoned.

(51) Int. Cl. G11B 3/64

(52) U.S. Cl. 369/84; G9B/3.097

(57) ABSTRACT

A multi-station audio distribution apparatus having at least two listening stations, a data control mechanism and a listening station interface mechanism disposed between the listening stations and the data control mechanism. Each of the listening stations has a user input in the form of a bar code scanner to enter an audio material selection and each has an audio output. The data control mechanism retrieves digitized audio material corresponding to each of the user's audio material selections. The listening station interface mechanism transfers the user's input from each of the listening stations to the data control mechanism, receives the digitized audio materials corresponding to each user's input from the data control mechanism, converts the digital audio materials to analog audio signals and transfers the analog audio signals to each of the respective listening stations for the audio output. An apparatus for recording a custom compact disc at a retail premises, comprising a music memory containing a plurality of digitally-stored music selections; a plurality of preview stations distributed throughout the retail premises; a plurality of compact disc cutters; and a main computer connected to the memory, to the preview stations, and to the compact disc cutters.

This application is a continuation in part of co-pending U.S. patent application Ser. No. 09/007,530, filed Jan. 15, 1998, which is a continuation of co-pending U.S. patent application Ser. No. 08/760,640, filed Dec. 4, 1996. This application is being filed under 37 C.F.R. §1.53(b).

### BACKGROUND OF THE INVENTION

This invention relates to a sound sampling device and more particularly to a multi-station audio distribution apparatus for sampling audio material.

Few retail music stores allow test sampling of the compact discs and/or cassettes that they sell. Thus, a music consumer is left to rely on the radio stations to first hear what may be contained on a compact disc. Radio stations, however, generally play only one selection from a compact disc that may contain ten or more musical selections. The result is that a musical consumer buys a compact disc based on the one selection they've heard only to be disappointed by the additional selections, which are not equivalent in quality or are not to the liking of the consumer. After repeated occurrences of the afore described situation, the disappointed consumer will inevitably meet a level of frustration at which point they will buy only a compact disc containing a single selection, at a much lower cost than the album compact disc, or will stop buying compact discs altogether. In either situation, the profits of the retail music store are reduced.

Those retail music stores that do allow test sampling, do so by actually opening a compact disc or cassette and inserting the cassette or disk into the player for the consumer to hear. Generally, the store is limited to one or two players and the retail store will only open those discs which it believes will be popular and will sell. The limitations are thus apparent, a retail music store may be full of customers yet only one or two may listen to a musical sample. Further, those consumers that are interested in non-mainstream music are left in the cold with no opportunity to sample their preferred music.

Based on the foregoing, there is a need for an apparatus that will allow a number of consumers to simultaneously listen to different discs of all types of music and will allow the user to hear more than a sample of one selection contained on the compact disc.

There is also a need for an apparatus that will allow a number of consumers to simultaneously record custom compact discs at the retail premises from the samples heard.

### SUMMARY OF THE INVENTION

A multi-station audio distribution apparatus having at least two listening stations, a data control mechanism and a listening station interface mechanism disposed between the listening stations and the data control mechanism. Each of the listening stations has a user input in the form of a bar code scanner to enter an audio material selection and each has an audio output. The data control mechanism retrieves digitized audio material corresponding to each of the user's audio material selections. The listening station interface mechanism transfers the user's input from each of the listening stations to the data control mechanism, receives the digitized audio materials corresponding to each user's input from the data control mechanism, converts the digital audio materials to analog audio signals and transfers the analog audio signals to each of the respective listening stations for the audio output. An apparatus for recording a custom compact disc at a retail premises, comprising a music memory containing a plurality of digitally-stored music selections; a plurality of preview stations distributed throughout the retail premises; a plurality of compact disc cutters; and a main computer connected to the memory, to the preview stations, and to the compact disc cutters.

An object and advantage of the present invention is that the multi-station audio distribution apparatus may utilize multiple listening stations that are controlled by a single data control means.

Another object and advantage of the present invention is that bar code scanning may be used to select the desired audio material.

Another object and advantage of the present invention is that random access to audio material is provided at any and all of the listening stations.

Yet another object and advantage of the present invention is that data related to the selected audio material may be displayed at each listening station. As well, apparatus adjustments such as forwarding/reversing to a different track of the audio material, fast forwarding/reversing through a selected audio track and volume control may also be provided at each listening station.

Still another object and advantage of the present invention is that low voltage wiring is used to connect each listening station to the listening station interface means.

Another object and advantage of the present invention is that the multi-station audio distribution apparatus performs playback of audio material stored in multiple digital formats.

Another object and advantage of the present invention is that the multi-station audio distribution apparatus provides scalable architecture that can grow from a small to a massive apparatus.

Another object and advantage of the present invention is that any number of customers can simultaneously record custom compact discs at the retail premises from the samples heard at the listening stations.

Another object and advantage of the present invention is that there may be a preview station in each area of the retail premises corresponding to a particular music genre such as rock, folk, classical, etc. The customer may move around the store, scanning CDs of each genre and adding to the selections to be recorded on his custom compact disc.

Another object and advantage of the present invention is that there may be multiple CD cutters in the store, so that several customers may have their CDs recorded simultaneously.

### BRIEF DESCRIPTION OF THE DRAWINGS

FIG. 1 depicts components of one listening station, one listening station interface means and the data control means of the present invention;

FIG. 2 depicts the layout of the present invention with its single data control means and multiple listening stations and listening station interface means;

FIG. 3 is a block diagram of an apparatus for recording a custom compact disc at a retail premises;

FIG. 4 is a block diagram of the preview station of the apparatus of FIG. 3;

FIG. 5 is a block diagram of the CD cutter of the apparatus of FIG. 3; and

FIGS. 6A-6C are flowcharts of a method of recording using the apparatus of FIG. 3.

### DETAILED DESCRIPTION OF THE PREFERRED EMBODIMENT

The multi-station audio distribution apparatus 10 generally comprises three component parts, a listening station 20, a listening station interface means 40 and a data control means 60.

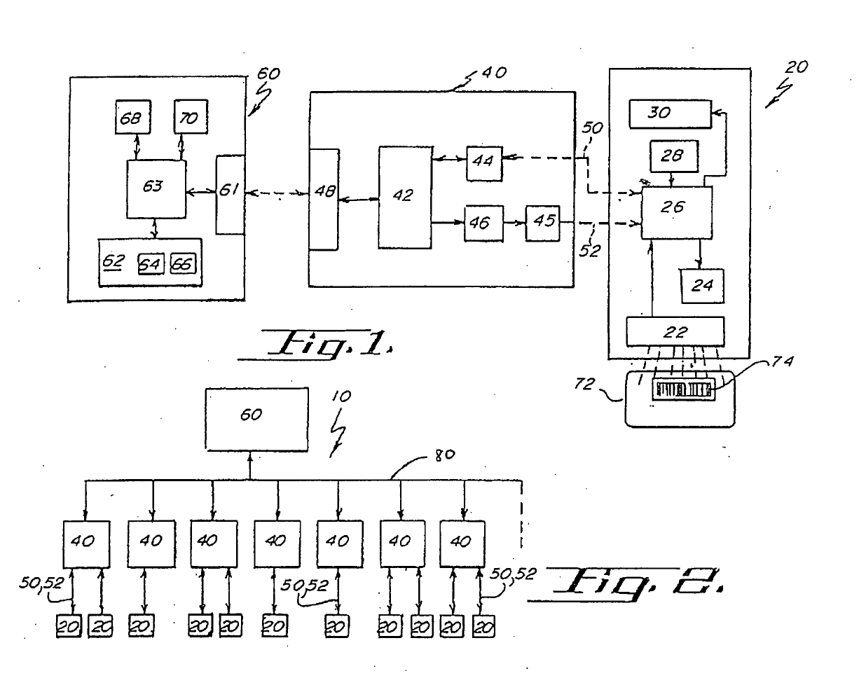

The layout of the listening station 20 is shown in FIG. 1. The listening station 20 at a basic level incorporates a user input in the form of a bar code scanner 20, an audio output 24, which may be a speaker and/or a standard stereo phono jack attached to headphones, and a software controlled microcontroller 26. The bar code scanner 22 and audio output 24 are tied to the microcontroller 26 which handles the transfer of all inputs into the listening station 20 and all outputs out of the listening station 20. The listening station 20 may further incorporate a keypad 28 and a visual display 30 such as a liquid crystal display. The keypad 28 can be used to input apparatus adjustments such as volume control, audio track selection and speed of playback. Further, the keypad 28 may be enabled for other input functions such as “help”, “price”, “additional information”, “similar music”, and “interview with artist or author”. The visual display 30 can be used to display informational data relating to selected audio material such as the title of a track, name of the artist or author, price, label, genre, media, etc. As with the bar code scanner 22 and audio output 24, the keypad 28 and visual display 30 are tied to the software controlled microcontroller 26 to handle inputs to and outputs from the listening station 20.

The listening station interface means 40 is also shown in FIG. 1. Depending on hardware configuration, the listening station interface means 40 may be adapted to accommodate one or two listening stations 20. Each listening station interface means 40 is generally in the form of a circuit board powered by low voltage direct current. Contained within the circuit board is a microcontroller 42 under program control having random access memory and read only memory, a digital interface 44, an analog interface 45, a digital to analog converter 46 and a data control means interface 48. The digital interface 44 is tied to the microcontroller 42 and is connected to the listening station 20 via a low voltage digital interface cable 50. The digital to analog converter 46 is also tied to the microcontroller 42 and is connected to the listening station 20 through the analog interface 45 via a low voltage analog interface cable 52. The microcontroller 42 is connected to the data control means 60 via the data control means interface 48. The microcontroller 42 serves as the data and audio signal transfer mechanism between the data control means 60 and the listening station 20.

The data control means 60, see FIG. 1, comprises a standard computer platform that incorporates a power supply, a backplane/bus 61 that is connectable to the data control means interface 48 of the listening station interface means 40, a microprocessor 63, random access memory, and interfaces to various peripherals such as disk drives that operate in conjunction with disk controllers, modems, video displays, keyboards, and tape backup units. The data control means 60, or computer platform, utilizes operating system software 62 (e.g. UNIX) that has low level device drivers 64, file management utilities 66 and further utilizes application software 68 that operates within the computer platform to implement the full functionality of the apparatus 10. The computer platform also incorporates high-speed random access storage of audio material in digital form; the audio material is contained in the data files stored on internal or external hard drives 70 that are connected to interfaces within the computer platform. The data control means 60 is connected to the listening station interface means 40 via the data control means interface 48 which is a computer bus.

The layout of the multi-station audio distribution apparatus 10 is shown in FIG. 2, its operation as applied to a retail music store is preferably described as follows. A user selects a music CD (compact disc) 72 from among those offered for sale. The user takes the CD 72 to a nearby listening station 20, puts on the attached headphones and passes the bar code 74 that is imprinted on the CD label under the bar code scanner 22.

The bar code scanner 22 transmits the bar code 74 through a serial data connection to the software controlled microcontroller 26 contained within the listening station 20. This data is received by the micro controller 26 and temporarily stored in RAM under program control. The program packetizes the data and re-transmits it to the listening station interface means 40 through the digital interface cable 50, which is a 6-conductor modular cable. The data packet is received, after passing through the digital interface 44, as a serial bit stream by the listening station interface means' microcontroller 42 and temporarily stored in RAM under the microcontroller's (42) program control.

The microcontroller (42) program waits for a request from a device driver 64 within the data control means 60 before sending the bar code data back through the data control means bus interface 48 to the data control means 60. The device driver 64 polls each listening station interface means 40 approximately every 500 microseconds to exchange data, using an I/O (input/output) address within the data control means 60. The device driver 64 passes the bar code data to the application software 68 running on the data control means 60. The application software 68 then performs a database search against an index of all such bar codes contained within the data control means 60. This database and its index are created before the application software 68 is executed.

Assuming a match is found in the index, the corresponding database record is retrieved from a master file on the hard drive 70. This record contains informational data items relating to the CD 72 selected by the customer, such as artist, title, label, genre, media, bar code, price and filename. These informational data items are transmitted back to the listening station 20 through the chain described above (i.e. from the data control means 60 to the listening station interface means 40 via the data control means interface 48, then to the listening station 20 via the digital interface 44 and the digital interface cable 50). The informational data items can be displayed on the visual display for review by the user.

The filename retrieved from the database record is then used by the data control means 60 to access the audio material stored in digital form as a file on the hard drive 70. This function is performed by the operating system software 62 under the direction of the application software 68. Blocks of data are read from the hard drive 70, passed through a disk controller and temporarily buffered in RAM (random access memory). The application software 68 processes a “header” portion of the file which consists of approximately one kilobyte of data; the bytes of data include duplicates of fields contained in the master database as well as the compression method used to encode the audio material. The application software 68 then strips the header from the file and instructs the device driver 64 to send the remainder of the file to the listening station interface means 40, one “word” (i.e. 16 bits) at a time. This file of audio material can be mono or stereo and can be encoded as linear, uLaw, ADPCM or other algorithms at various digitization rates.

The microcontroller 42 within the listening station interface means 40 stores each word of the audio material in a FIFO (first in, first out) buffer, reporting the buffer status (fill, half-empty, empty) back to the device driver 64 as needed to retrieve further audio material. The program directing operation of the microcontroller 42 empties the buffer by sending bytes of the audio material to the Digital-to-Analog converter 46, which translates the encoded bytes into an analog stereo signal. This analog stereo signal is amplified within the listening station interface means 40 before being sent to the listening station 20 through the analog interface 45 and the analog interface cable 52, which is an 8-conductor modular cable that is separate and distinct from the digital interface cable 50 described previously. The amplitude of the analog stereo signal is controlled by the listening station interface means' circuitry. The analog stereo signal received by the listening station 20 is passed directly to the audio output 24 which may be a speaker or a phono jack attached to headphones. The user hears the analog stereo signal from the selected CD 72 approximately a second or two after scanning the bar code 74.

A sample of three or more tracks from the CD 72 are typically stored on hard drive(s) in digital form. The visual display 30 may show the track number that is currently playing, as determined by the application software 68. The user may push a button on the keypad 28 at the listening station 20 to hear the next track or a previous track from the same CD 72. In addition, the user may press a “volume up” or “volume down” button on the keypad 28 to adjust the volume of the analog stereo signal. These keypad 28 depressions are read by the software controlled microcontroller 26 within the listening station 20 and are passed to the listening station interface means 40, to the device driver 64 and to the application software 68 for interpretation, action and responsive outputs consistent with apparatus adjustment keypad inputs. Other keypad buttons can be enabled for functions such as “help”, “price”, “additional information”, “similar music”, “interview with artist.” The customer merely has to scan another CD 72 to start the process over again. With the potential for many listening stations 20 in a single store location, the apparatus 10 depends on very high-speed processors and data storage.

As can be seen in FIG. 2, the apparatus 10 includes a dedicated, non-switched network 80 connecting the data control means 60 to each of the listening station interface means 40. Preferably, the listening stations, data control means, and listening station interface means reside within a single premises, such as a retail music store, bookstore, or library as described above.

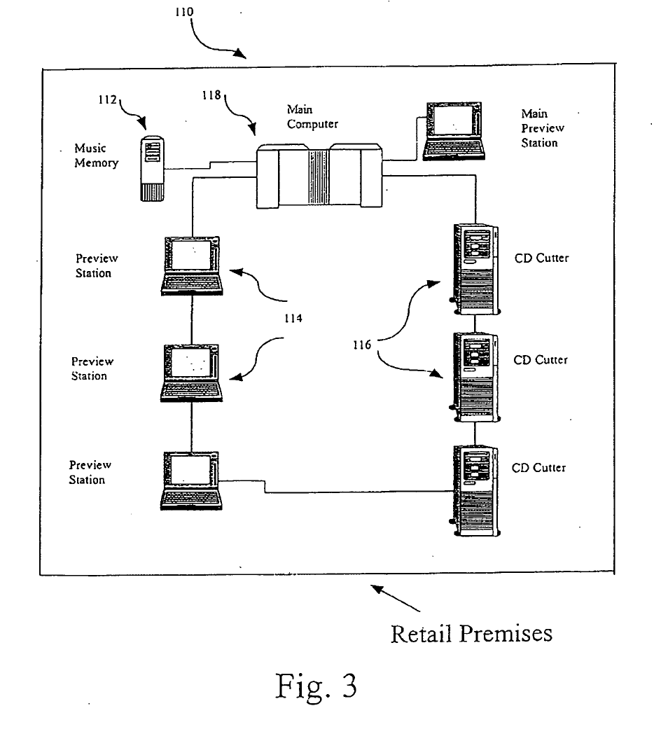

A second embodiment of the present invention is shown generally in FIGS. 3-6 as reference numeral 110.

An apparatus 110 for recording a compact disc at a retail premises, whereby the customer selects the desired music tracks on the compact disc from original compact discs stored digitally, comprises: a music memory 112 containing a plurality of digitally-stored music selections; a plurality of preview stations 114 distributed throughout the retail premises, and especially such that there is a preview station in each area of the retail premises corresponding to a particular music genre such as rock, folk, classical, etc.; a plurality of compact disc cutters 116, which may also be distributed throughout the retail premises; and a main computer 118 connected to the music memory 112, to the preview stations 114, and to the compact disc cutters 116.

The music memory 112 may preferably comprise one or more hard disc drives I 12. Having multiple hard disc drives allows for virtually unlimited storage of music selections. The hard disc drives 112 are preferably located in the retail premises, but some of them may be off the retail premises and connected to the main computer by remote connections such as telephone lines.

The music memory 112 contains music selections corresponding to entire original compact discs. The compact discs are digitally stored in the music memory 112. The digital storage may either be uncompressed (i.e., the entire original compact disc is stored digitally without compression), or some compression scheme such as MP3, ADPCM, Liquid Audio, or Real Audio may be employed to compress the music selections to optimize the music memory. Each music selection is stored in the music memory along with all pertinent information such as the name of the label, the artist's name, the CD title, the genre, the track number, etc.

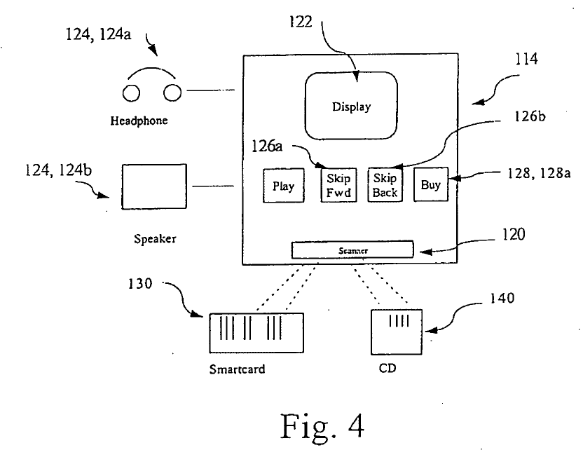

Each preview station 114 is schematically shown in FIG. 4 and comprises: a bar-code scanner 120, a digital display 122, sound reproduction means 124, track selection means 126, and compact disc purchase means 128. The sound reproduction means 124 may be either a headphone 124a or a speaker 124b. The track selection means 126 preferably comprises a skip forward button 126a and a skip back button 126b. The compact disc purchase means 128 is preferably a buy button 128a, but can be any means of signaling the apparatus that the customer wishes to purchase the track just played.

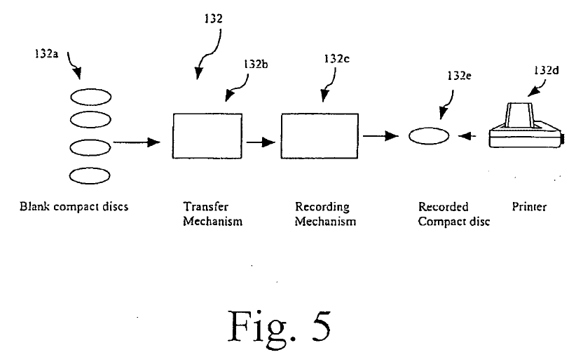

The compact disc cutter 132 further comprises (FIG. 5): storage 132a for a number of blank compact discs; a transfer mechanism 132b for removing a blank compact disc from the compact disc storage 132a; a recording mechanism 132c for recording music selected from the music memory 112 on a blank compact disc; and a printer 132d adapted to print identifying information on the compact disc. The identifying information may include: the date of manufacture, the retailer's name, and the titles of the music selections cut into the compact disc.

The apparatus 110 also includes a plurality of scannable purchase cards 130, each having a unique bar code keyed to the music selections chosen by the customer. The purchase cards 130 may be Smartcards which also include a memory for storing information such as the authorized amount of music which the customer is allowed to purchase with the purchase card 130.

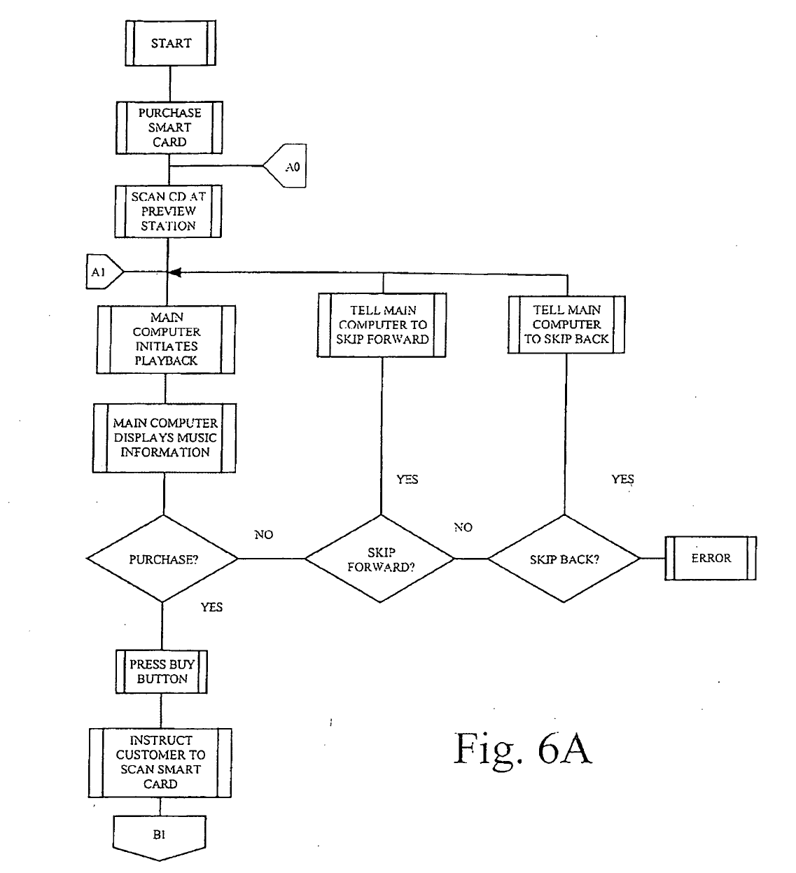

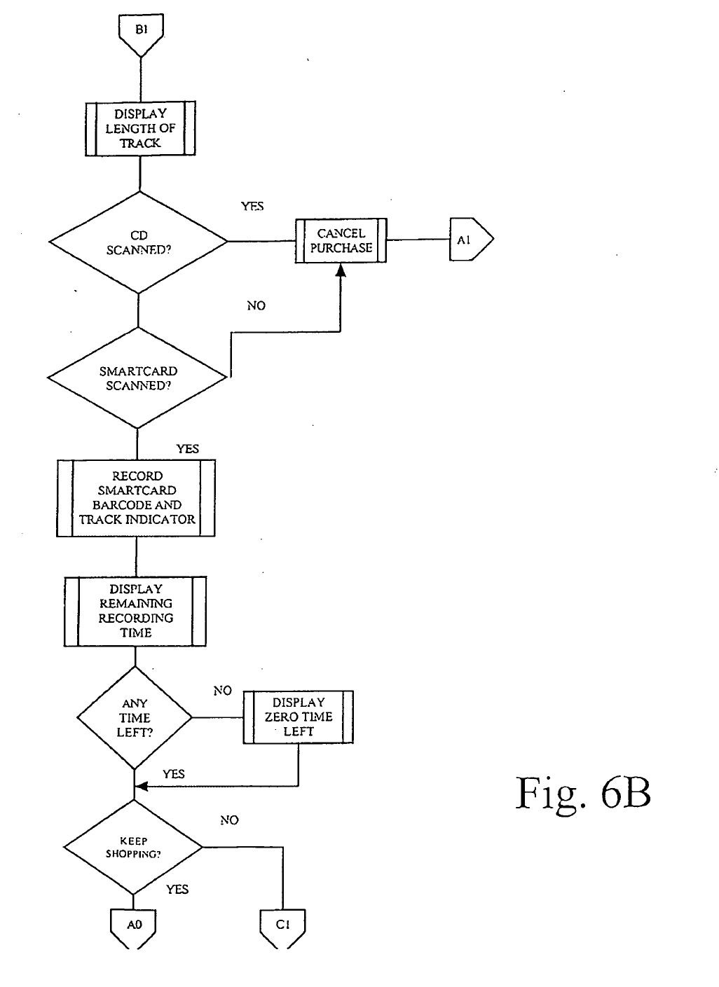

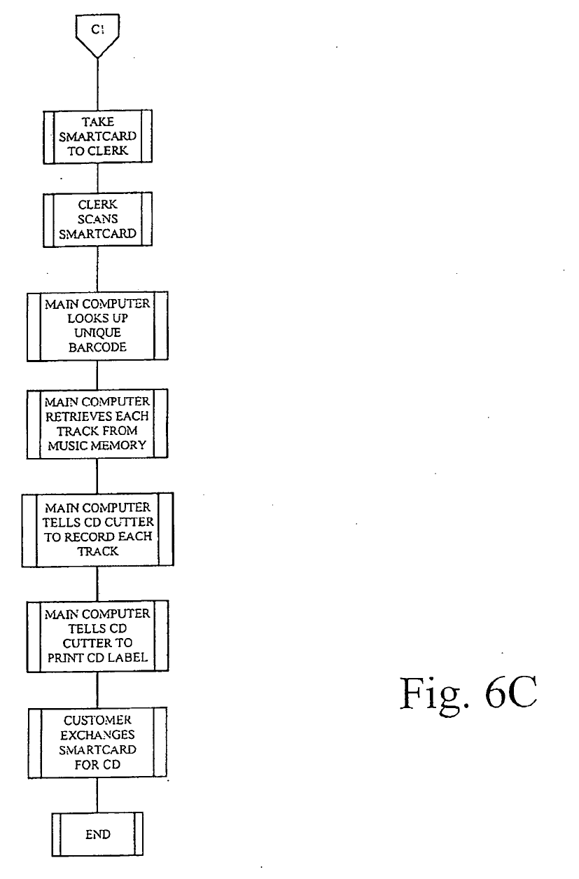

A method of recording a compact disc using the apparatus 110 is shown in the flowcharts of FIGS. 6A-6C.

In one embodiment of the method, known as “pay first then pick”, the customer purchases a purchase card 130 from the retail establishment. The purchase card 130 will be encoded with a unique barcode (or a magnetic strip with store name, billing information, etc.). Purchase can be made either from a store employee or from an automated vending machine. Providing different colored purchase cards 130 gives the shopper a choice to pre-purchase different music capacities (in minutes) allowed on each CD. The allowable capacity of recorded music per single CD will vary depending on the audio quality stored in the system, or be the same as a regular CD (75 minutes) if uncompressed PCM digital format is used. The main computer 118 will recognize all predefined recording capacities of each purchase card 130 by reading a unique check-sum of the last two digits of the barcode when scanned at any preview station 114.

After the purchase card 130 has been purchased, the shopper may proceed with his music previewing and selection of songs and then CD recording. (It is not, however, required for the shopper to use the purchase card 130 in order to preview music and purchase standard CDs offered in the store inventory).

To preview CDs, the shopper simply scans the desired CD (which generally has a barcode on the packaging) at any of the preview stations 114. The main computer 118 then initiates a playback of the requested CD. Performer, CD title and the track number are shown on the digital display 122 during playback. Pressing the skip forward button 126a or skip back button 126b allows the shopper to maneuver through all tracks of the CD. Each track sample may preferably be 45 seconds in length, but may be longer if desired.

When the shopper hears and wishes to purchase a desired song, he will need to press the buy button 128a conveniently located on the preview station 114. Immediately after the buy button 128a is pressed, the music playback ends, and audible messages instruct the shopper to scan the purchase card 130 under the barcode scanner 120 of the preview station 114. The digital display will then show the length of that specific track (same price is charged for each track of every CD). If the purchase card 130 is not scanned within a short time, or if any CD is scanned again the “buy” mode for that specific track will be cancelled. However, if the purchase card 130 is scanned within a predetermined amount of time, the digital display 122 will show the remaining recording time available using that purchase card 130. The shopper can repeat this step on any number of preview stations 114 until he runs out of allowable recording time. If that occurs, every station 114 will instruct him that he is out of space and the system will disallow further purchasing of music.

Scanning a unique barcode on the purchase card 130 allows the apparatus to keep track of all song selections and their originator/owner at any station. Linking each song to a single unique barcode provides logical means to organize all tracks and record a custom CD by each individual shopper.

Once the song selection has been completed, the shopper hands the purchase card 130 to the store clerk at the checkout counter. The store clerk scans the purchase card 130 at the main central station (which may simply be a preview station 114, and may be protected by a security code) and returns the card to the customer. Scanning the card 130 invokes the recording of the custom CD, as all of the selected tracks have been keyed to the unique barcode. Depending on the length and number of tracks as well as the speed of the CD cutter 132, the entire custom CD 132e can vary in time. Each track is identified by the CD title, track names, and length printed on one side of the CD 132e by the printer 132d.

After the CD 132e has been recorded, the shopper would exchange the purchase card 130 for the custom CD 132e. The purchase card could not be used on the apparatus again.

Optional equipment could be installed to allow the shopper to customize the CD recording. Multiple video terminals with barcode scanners, keyboards, mouse, etc. would be connected to the main computer 118 allowing shoppers to customize graphic designs, track sequence selections, and custom messages (gifts, etc.) A second embodiment of the method, known as “pick first then pay”, is identical to the “pay first then pick” method except that the purchase card 130 would be given to the shopper at no cost at the beginning of the method (again, color-coded for length of recording). However, at the end of track selection and prior to the custom CD recording, the shopper would need to pay for his selected music tracks (cost of each track may vary) or simply walk away and pay nothing and get nothing.

To pay for the selected tracks and allow custom CD recording, the shopper would hand the purchase card 130 to the store clerk to be scanned at the main central station as above. Scanning the purchase card 130 provides the store employee visual verification of total number of tracks, total length in minutes recorded and total purchase price. If connected to the store's point-of-sale system, CD recording, billing, and receipt printing can be accomplished after the purchase card's barcode has been scanned at the checkout counter. After payment has been made, CD recording is begun as above. After the CD is recorded, the customer is given the custom CD in exchange for the purchase card.

While the above describes a retail music store application, the same might be applied to a bookstore or even a library to sample books on CD or tape.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

1-16. (canceled)

17. An apparatus for recording a custom compact disc at a retail premises, whereby the customer selects desired music tracks on the compact disc from original compact discs stored digitally, comprising:
a memory including a plurality of digitally-stored music selections;
a plurality of preview stations distributed throughout the retail premises, each of the plurality of preview stations configured to display a title of each track from an album comprising a predetermined number of tracks, and to allow a user to select a particular number of tracks from the album, wherein the particular number is less than the predetermined number;
a plurality of compact disc cutters; and
a main computer connected to the memory, to the preview stations, and to the compact disc cutters.

18. A method of recording a custom compact disc at a retail premises having a main computer and a plurality of compact disc cutters and preview stations connected to the main computer, whereby the customer selects the desired music tracks on the compact disc from original compact discs stored digitally in a music memory by scanning a barcode on the compact disk packaging at a preview station, comprising the steps of:
(a) the customer obtaining a purchase card with a unique barcode number and an authorized amount from retail premises personnel;
(b) the customer scanning a disc barcode for a compact disc to be sampled at a preview station;
(c) playing each track corresponding to the disc barcode at the preview station;
(d) the customer selecting each track to be purchased, up to the authorized amount, by pressing a buy button at the preview station, wherein a particular number of tracks may be selected from an album comprising a predetermined number of tracks and wherein the particular number is less than the predetermined number;
(e) scanning the purchase card to obtain the unique barcode;
(f) keying each selected track to the unique barcode;
(g) scanning the purchase card at a checkout station to obtain the unique barcode; and
(h) recording the selected tracks keyed to the unique barcode on a compact disc cutter.

19. A method of recording a custom compact disc at a retail premises having a main computer and plurality of compact disc cutters and preview stations connected to the main computer, whereby the customer selects the desired music tracks on the compact disc from original compact discs stored digitally in a music memory by scanning a barcode on the compact disk packaging at a preview station, comprising the steps of:
(a) the customer obtaining a purchase card with a unique barcode number and an authorized amount from retail premises personnel;
(b) the customer scanning a disc barcode for a compact disc to be sampled at a preview station;
(c) the preview station transmitting the disc barcode to a main computer;
(d) the main computer retrieving a digitally-stored track corresponding to the disc barcode from a music memory;
(e) the main computer transmitting the digitally-stored track to the preview station;
(g) the customer selecting the track by pressing a buy button if he wishes to purchase the track;
(h) instructing the customer to scan the purchase card at the preview station;
(i) recording and displaying the length of the selected track;
(j) notifying the customer if the total length of all selected tracks exceeds the authorized amount on the purchased card;
(k) keying the selected track to the unique barcode;
(l) scanning the purchase card at a preview station located in the retail premises check-out area;
(m) transmitting the unique barcode to the main computer;
(n) the main computer retrieving each selected track from the music memory;
(o) the main computer transmitting each selected track to a compact disc cutter;
(p) the compact disc cutter recording each selected track on a blank compact disc, producing a recorded compact disc, wherein the recorded compact disc includes a particular number of tracks selected from an album comprising a predetermined number of tracks and wherein the particular number is less than the predetermined number; and
(q) the customer exchanging the purchase card for the recorded compact disc.

20. The method of claim 19, wherein the customer purchases the purchase card before selecting tracks to be purchased.

21. The method of claim 19, wherein the customer purchases the purchase card after selecting tracks to be purchased.
